(19) United States
(12) Patent Application Publication
(10) Pub. No.: US 2024/0249013 A1
(43) Pub. Date: Jul. 25, 2024

(54) DATA PROTECTION THROUGH COLLABORATIVE ASSOCIATION

(71) Applicant: International Business Machines Corporation, Armonk, NY (US)

(72) Inventors: Ryan Michael Sparks, Tulsa, OK (US); Jean Pommier, San Jose, CA (US); Greg Pollack, Daytona Beach, FL (US); Zachary A. Silverstein, Austin, TX (US)

(21) Appl. No.: 18/101,043

(22) Filed: Jan. 24, 2023

(51) Int. Cl. G06F 21/62; G06F 16/2457

(52) U.S. Cl. CPC G06F 21/6227; G06F 16/24578

(57) ABSTRACT

An example operation may include one or more of receiving a request to modify a software artifact stored on a host platform, querying a database based on a user identifier associated with the request to retrieve historical communications of a user from the database, executing an artificial intelligence (AI) model based on the historical communications to determine whether the user is authorized to modify the software artifact, and in response to the determination, preventing the request to modify the software artifact from being performed to the software artifact on the host platform.

### BACKGROUND

Data recovery is an information technology (IT) designed to prevent or otherwise minimize data loss and business disruption resulting from destructive events that occur to a host environment, such as a cloud platform, web server, database, or the like, which host and manage software artifacts including applications, services, programs, scripts, and the like. Destructive events may include equipment failure, cyberattacks, natural disasters, and the like. To prevent such destructive events from damaging the runtime, the hots platform may generate a backup site at a remote system which contains a backup copy of the host environment. This backup copy can be used to recover the host environment when it is damaged.

However, other destructive actions such as deleting a software artifact from the host environment may also cause significant problems and may not be fixed with current data recovery process. For example, a first developer may build a software artifact within a tenant environment (e.g., a test environment, etc.) hosted on the host platform. A second developer of the same tenant may try to delete the software artifact from the storage within the test environment of the tenant. In this case, the deletion of the software application can be a surprise to the first developer and also be unwanted. Furthermore, the second developer may not have authorization to delete such a software artifact. However, at present, there is now way for the system to determine whether a user is authorized to take such destructive action.

### SUMMARY

One example embodiment provides an apparatus that includes a processor that may receive a request to modify a software artifact stored on a host platform, query a database based on a user identifier associated with the request to retrieve historical communications of a user from the database, execute an artificial intelligence (AI) model based on the historical communications to determine whether the user is authorized to modify the software artifact, and in response to a determination that the user is not authorized, prevent the request to modify the software artifact from being performed to the software artifact.

Another example embodiment provides a method that may include one or more of receiving a request to modify a software artifact stored on a host platform, querying a database based on a user identifier associated with the request to retrieve historical communications of a user from the database, executing an artificial intelligence (AI) model based on the historical communications to determine whether the user is authorized to modify the software artifact, and in response to the determination, preventing the request to modify the software artifact from being performed to the software artifact on the host platform.

A further example embodiment provides a computer-readable medium comprising instructions, that when read by a processor, may cause the processor to perform a method that includes one or more of receiving a request to modify a software artifact stored on a host platform, querying a database based on a user identifier associated with the request to retrieve historical communications of a user from the database, executing an artificial intelligence (AI) model based on the historical communications to determine whether the user is authorized to modify the software artifact, and in response to the determination, preventing the request to modify the software artifact from being performed to the software artifact on the host platform.

### BRIEF DESCRIPTION OF THE DRAWINGS

FIG. 1A is a diagram illustrating a computing environment according to an embodiment of the present instant solution.

FIG. 1B is a diagram illustrating a cloud computing environment according to an example embodiment.

FIG. 2A is a diagram illustrating an example of abstraction model layers of a cloud platform according to an example embodiment.

FIG. 2B is a diagram illustrating a host platform that can determine whether a user has authority to perform a destructive action using historical communications according to example embodiments.

FIG. 3A is a diagram illustrating a permissioned network, according to example embodiments.

FIG. 3B is a diagram illustrating another permissioned network, according to example embodiments.

FIG. 3C is a diagram illustrating a further permissionless network, according to example embodiments.

FIG. 3D is a diagram illustrating machine learning process via a cloud computing platform according to an example embodiment.

FIG. 3E is a diagram illustrating a quantum computing environment associated with a cloud computing platform according to an example embodiment.

FIG. 4A is a diagram illustrating a process of training an artificial intelligence module that may determine whether a user is authorized to perform a destructive action to a software artifact according to example embodiments.

FIG. 4B is a diagram illustrating a process of identifying patterns within historical communications via the artificial intelligence module, according to example embodiments.

FIG. 4C is a diagram illustrating a process of determining whether a destructive modification can be performed to a software artifact according to example embodiments.

FIG. 5 is a diagram illustrating a method of determining whether a user can modify a software artifact based on historical communications according to example embodiments.

FIG. 6 is a diagram illustrating an example system that supports one or more of the example embodiments described herein.

### DETAILED DESCRIPTION

It is to be understood that although this disclosure includes a detailed description of cloud computing, implementation of the teachings recited herein is not limited to a cloud computing environment. Rather, embodiments of the present instant solution are capable of being implemented in conjunction with any other type of computing environment now known or later developed.

The example embodiments are directed to a protective system that can prevent unauthorized users from destroying software artifacts. For example, the protective system can prevent an unauthorized user from deleting a software application from a shared/collaborative environment. Here, the protective system may analyze historical communications of the user requesting the deletion of the software artifact and determine, via execution of the AI module, whether the user is authorized to delete the software artifact based on evidence that is found in the historical communications. For example, the protective system may look for keywords related to destructive terms (e.g. delete, cut, destroy, trash, etc.) and a frequency of occurrence of such terms within the historical communications to determine whether a user is authorized to delete the software artifact. For example, a message may be sent to the user indicating that their software application will be deleted later that day. If the user were to respond with an OK or a Thank you, this is evidence that the user has such authorization to delete the software artifact. As another example, the authority may be identified constructively, for example, based on repeated occurrences of keywords and patterns of behavior.

As described herein, a software artifact may be program, a code module, a software application, a web service, an application programming interface (API) or the like. Meanwhile, destructive actions or modifications can include deletions but also other operations such as name changes to file names, archiving of files, asset movement, code modification, patching actions, temporary downtime/shutdown requests, migration requests, etc. The protective system uses an artificial intelligence (AI) module that includes one or more predictive models therein, such as neural networks, collaborative filtering networks, natural language processing (NLP) models, and the like.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure, including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure, including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community with shared concerns (e.g., mission, security requirements, policy, and compliance considerations). It may be managed by organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

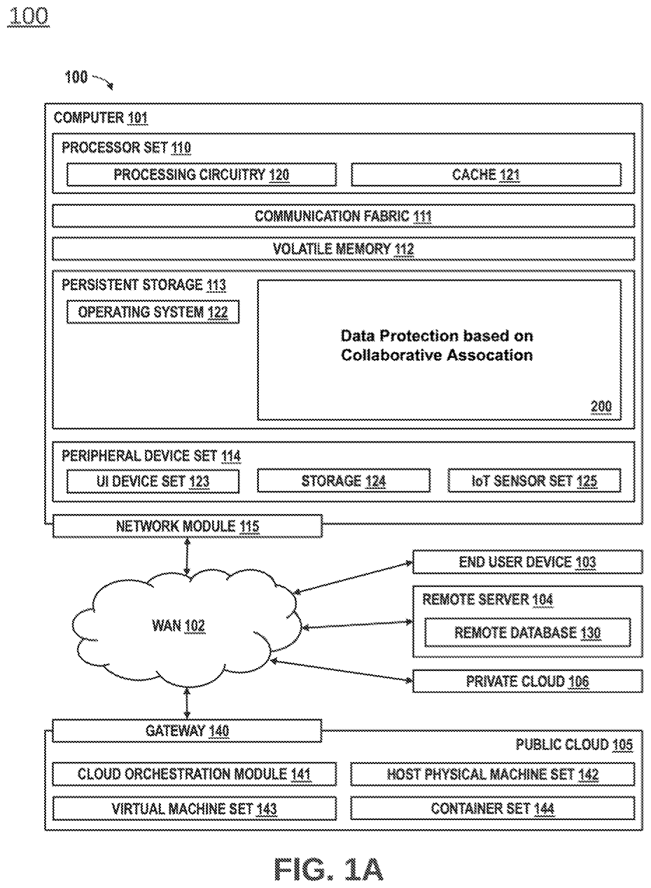

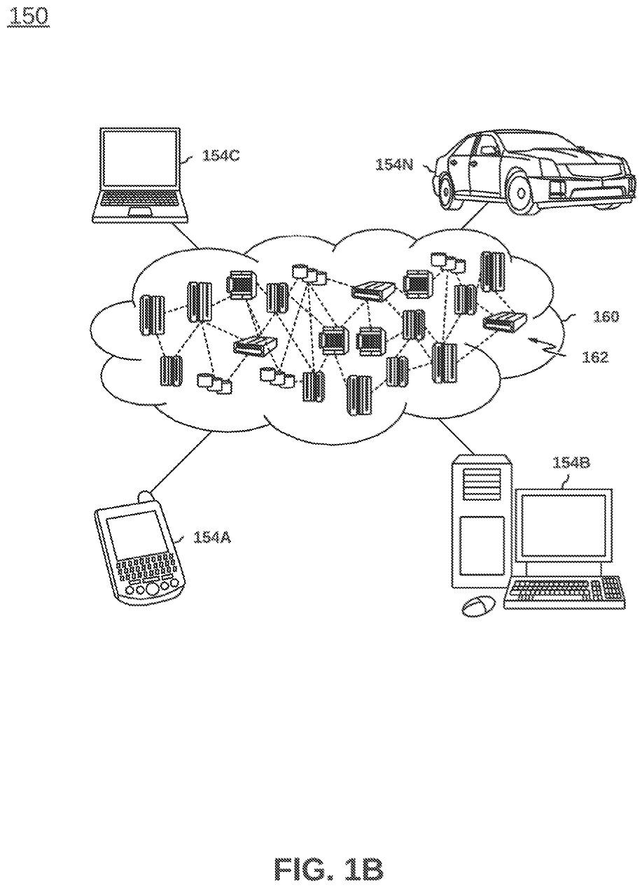

Referring now to FIG. 1A, a computing environment 100 is depicted. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart.

For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for executing at least some of the computer code involved in performing the inventive methods, such as data protection based on collaborative association 200. In addition to block 200, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric comprises switches and electrically conductive paths, such as the switches and electrically conductive paths that make up busses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

Referring now to FIG. 1B, an illustrative cloud environment 150 is depicted. As shown, cloud computing environment 160 includes one or more cloud computing nodes 162 with which local computing devices used by cloud consumers, such as, for example, personal digital assistant (PDA) or cellular telephone 154A, desktop computer 154B, laptop computer 154C, and/or automobile computer system 154N may communicate. Nodes 162 may communicate with one another. They may be grouped (not shown) physically or virtually in one or more networks, such as Private, Community, Public, or Hybrid clouds as described hereinabove, or a combination thereof. This allows cloud computing environment 160 to offer infrastructure, platforms and/or software as services for which a cloud consumer does not need to maintain resources on a local computing device. It is understood that the types of computing devices 154A-N shown in FIG. 1B are intended to be illustrative only and that computing nodes 162 and cloud computing environment 160 can communicate with any type of computerized device over any type of network and/or network addressable connection (e.g., using a web browser).

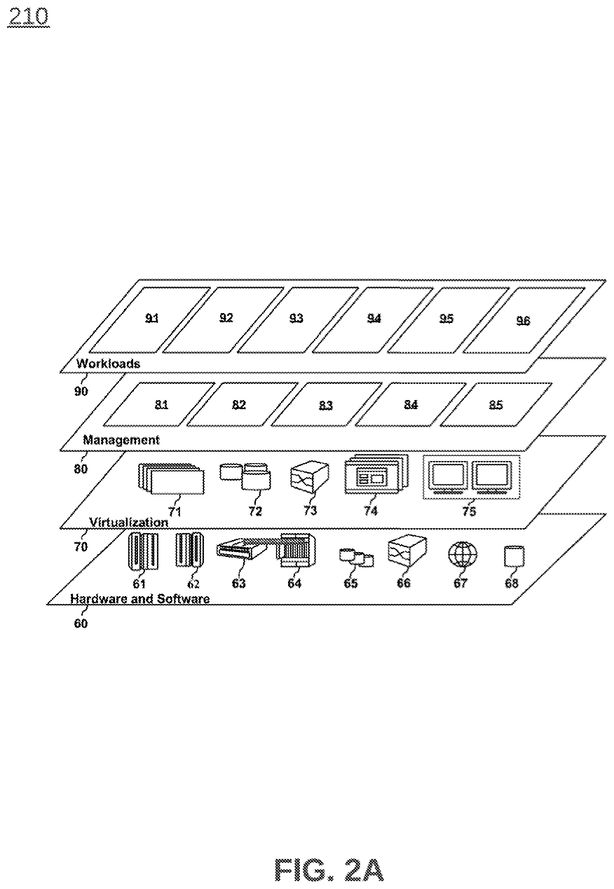

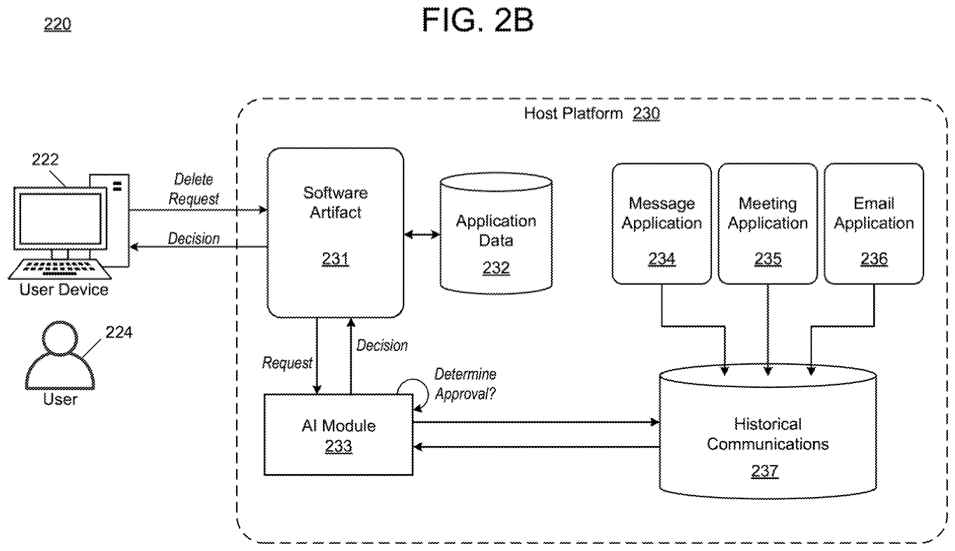

Referring now to FIG. 2A, a set of functional abstraction layers 210 provided by cloud computing environment 160 (FIG. 1B) is shown. It should be understood in advance that the components, layers, and functions shown in FIG. 2A are intended to be illustrative only, and embodiments of the instant solution are not limited thereto. As depicted, the following layers and corresponding functions are provided: Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68. Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment and billing or invoicing to consume these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and data protection processing 96.

FIG. 2B illustrates an environment 220 of a host platform 230 that determines whether a user (e.g., a software developer, etc.) is authorized to perform a destructive modification to a software artifact on the host platform 230 such as deleting the software artifact, changing its name, deleting data of the software artifact, and the like. For example, the host platform 230 may perform the data protection processing 96 shown in FIG. 2A. Referring to FIG. 2B, the host platform 230 hosts a software artifact in a collaborative runtime environment that is accessible to multiple users. For example, the runtime environment may be dedicated to a tenant instance that includes a group of users. Application data may be stored within a database 232. The application data may include the software artifact 231 (e.g., an executable file for launching and running the software artifact 231, etc.)

In this example, a user 224 connects to the host platform 230 via a user device 222 over a computer network (not shown). For example, the user device 222 may access the host platform and see a list of files or other content stored within the database 232. The user 224 may enter commands (e.g., via a mouse, cursor, pointer, keyboard, speech, motion, etc.) which requests a destructive modification (e.g., deletion, etc.) to the software artifact 231. For example, the user 224 may attempt to delete the software artifact 231 from its storage location on the host platform 220 (e.g., the database 232, etc.) Here, the request may be intercepted by or otherwise forward to an artificial intelligence (AI) module 233. For example, the host platform 220 may include an API that manages communications between the user device 222 and the database 232, or the like.

In some embodiments, the request may be intercepted by a server side module on the host platform which restricts the ability to make changes/deletions to files based on receiving some validation or verification that the necessary users may be contacted. In this case the request may be sent from the client's machine such as through a website to the server. The server receives the request, and may validate the request, for example, by inspecting the payload looking for an indicator from a previous step of an AI Module validation from the user. As another example, the server side module may take the request and metadata information and run it at time of receiving the deletion request and validate necessary notification or interaction with the other individuals.

In response to receiving the request, the AI module 233 may identify the user 224 who is associated with the request, for example, by a username, login name, email address, phone number, network address, or other identifying data included in the request. The AI module 233 may include one or more models such as neural networks, artificial intelligence models, collaborative filtering, NLP, and the like, which can analyze historical communications to determine whether the user 224 is authorized (allowed) to make such a modification to the software artifact 231.

For example, the AI module 233 may query a database 237 for historical communications of the identified user 224. For example, the database 237 may store all communications between all users of a particular tenant. To do this, the query may include an identifier of the user 224. The database 237 may be coupled to one or more communication applications including a message application 234, a meeting application 235, and an email application 235. These applications may also be hosted for the tenant only, and may not be accessible outside of the tenancy. It should be appreciated that the historical communications are not limited to email, meetings, and messaging, but may also include calls, meeting information including invites, meeting notes, meeting agendas, chat applications, etc. Furthermore, the AI module 233 may be integrated within one or more of the database 237 and the applications 234, 235, and 236. The integration may be performed via an operating system of the host platform 220.

According to various embodiments, the AI module 233 may use NLP to identify and extract keywords from the historical communications. The AI module 233 may build a temporary storage structure and store the extracted messages, keywords, etc., in a group for future reference by the models. Here, the AI module 233 may search for communications of the user 224 that refer to destructive events. As an example, cosine similarity and a corpus of destructive words could be used to identify historical communications that may contain relevant information. It should be appreciated that non-relevant communications (e.g., “I've ordered a new chair for my desk”, etc.) will be skipped or otherwise not used by the AI module 233. Further some text understanding or NLU algorithm could be used.

In some embodiments, the AI module 233 may look through the communication mediums (e.g., SLACK®, email, meeting data, SMS messages, etc.) for phrasing indicative of deletion. As an example, an instant message to the user that says, “Hi John, we're going to delete your application on BAW Tenant US1.” In response to the message, another historical communication may indicate that John approved of the deletion, for example, “No problem. Thanks for telling me.” This is evidence of an express approval that can be captured and used by the AI module 233.

As another example, the AI module 233 may look for constructive approval which may be based on a frequency of occurrence of such historical communications mentioning such destructive words in association with the software artifact. For example, the user 224 (John) received an email that said “John, we are going to delete your application on BAW Tenant US1.” In this example, the user 224 may not respond. Thus, no express approval is found. However, if multiple messages exist that also mention similar topics without express approval, the frequency of such messages may be determined by the AI module 233 to provide “constructive authorization” or “constructive approval” of the deletion operation.

When the AI module 233 determines that express approval or constructive approval is found, the AI module 233 may allow the request to be processed by the host platform 220. In other words, the AI module 233 may allow the user 222 to delete the software artifact 231 from the database 232. However, if the AI module 233 does not find approval of any kind, the AI module 233 may send an error message to the user device 222 and also prevent the request from being executed. For example, the AI module 233 may delete the request or otherwise prevent the request from being processed any further.

In some embodiments, an override function may be provided which can identify a role of the user 224 within the organization/tenant. In this case, if the user 224 is a predefined role (e.g., system admin, etc.) the AI module 233 may allow the request to go through even though approval is not found by the AI module 233. That is, the role of the user 224 can trigger an override of the error by the AI module 233. In this case, a user interface or other means may be displayed on a user interface of the user device 222 with a request for the user 224 to confirm the request to delete. Upon approval from the user 224 via the user interface, the software artifact 231 may be deleted.

The AI module 233 may be hosted on a centralized server. The software artifacts may be hosted on the same server or on another server or software as a service (SAAS) tenant. The historical data may be retrieved from various communication protocols, applications, etc., by integrating the AI module 233 into the various communication channels and applications via the operating system, or the like. The server may retrieve communications from such channels when determining whether to validate a user trying to destructively modify a software artifact.

For example, the server may run an integration process to query all communications from one or more of the applications 234, 235, and 236

The communications may include tenant interactions among users of a same tenant via one or more of the applications 234, 235, and 236. Also, the communications may be extracted from other non-tenant means such as SLACK® channel, email, etc. The centralized server would query these specific platforms/mediums to get communication history of the users. Then based on that communication history would allow or block an incoming request to delete data from the tenant, for example, via the user interface where the commands are being entered by the user 224 of the user device 222, through a DELETE HTTP Request, or the like.

In some embodiments, frequency of communication or relevant communication drives the concept forward because the AI module 233 can determine that the users are “aligned” in their understanding of assets that may be deleted, deprecated, etc. For example, if a first user (Jean) can delete an artifact that a second owner (Rob) is part of, the users will likely communicate frequently and this frequent communication implies that the two users are aligned and probably know or understand it.

Furthermore, often times in software there's the concept of a tenant admin who may have access/delete rights but not often embedded in all the sub applications, workflows, executions, assets, etc., which their tenant maintains. This is a dangerous scenario because the tenant admin may delete a sub-user's software artifacts or the tenant as a whole. In this case, the system can stop the deletion and verify the role of the user (i.e., system admin, etc.). Next, the AI module 233 can output a user interface on the user's screen with a request to “confirm” the deletion thereby receiving express approval via the user interface. However, it should also be appreciated that the AI module 233 may automatically allow the deletion based on the role of the user such as system admin.

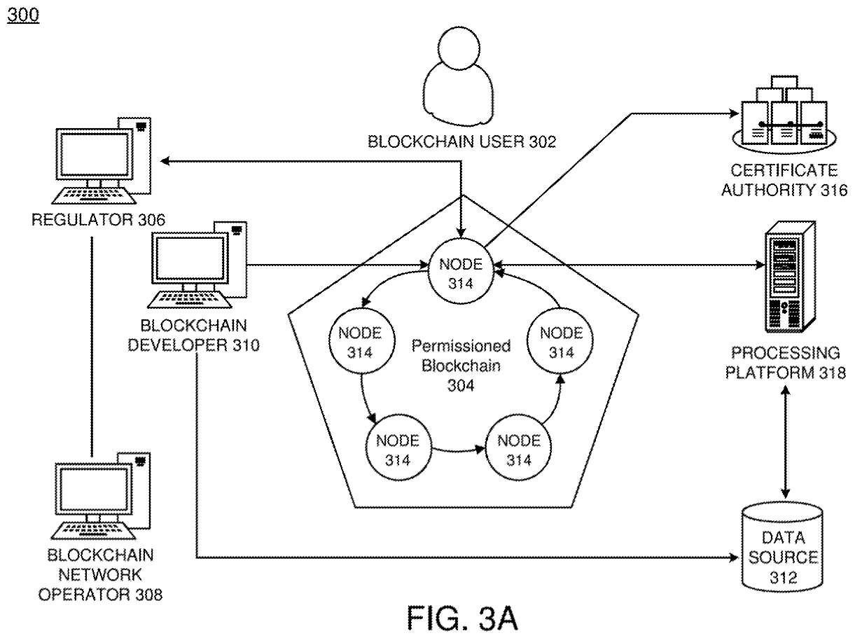

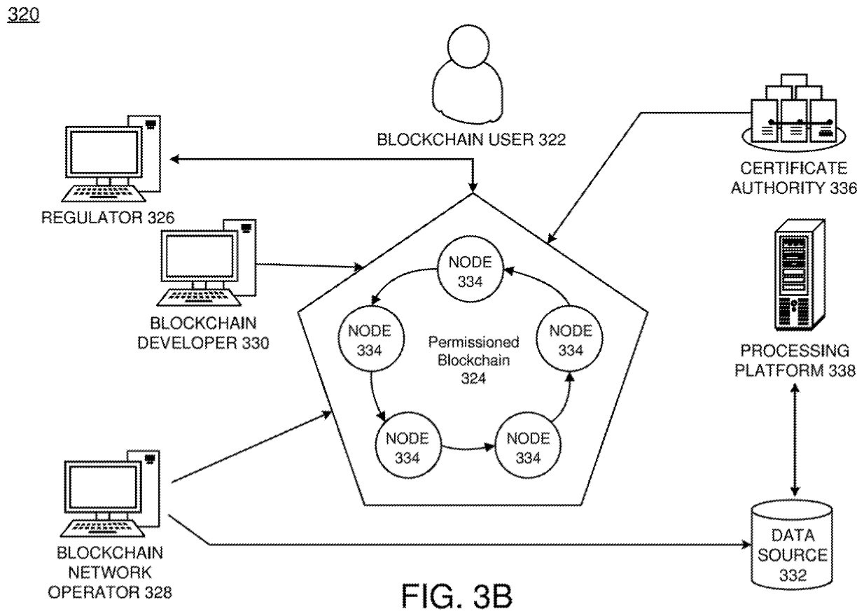

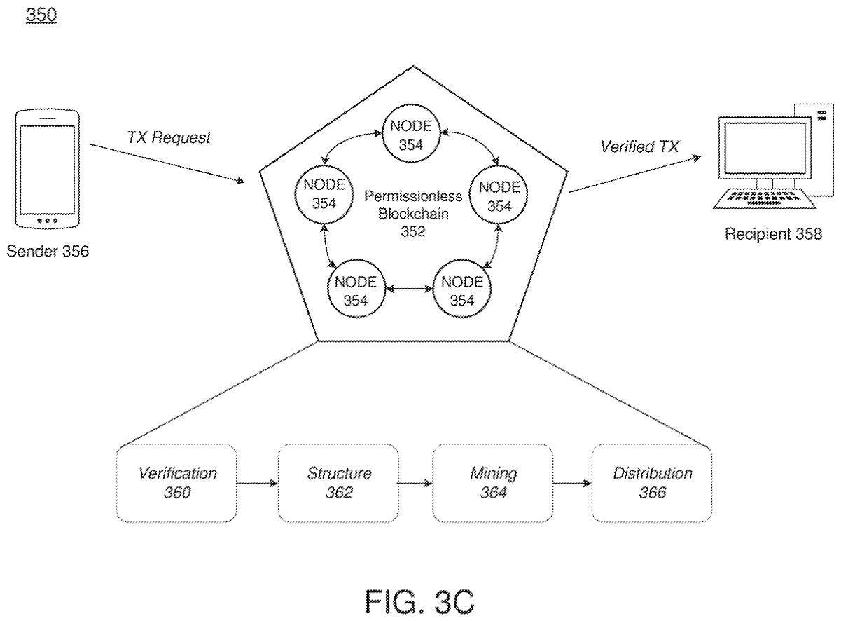

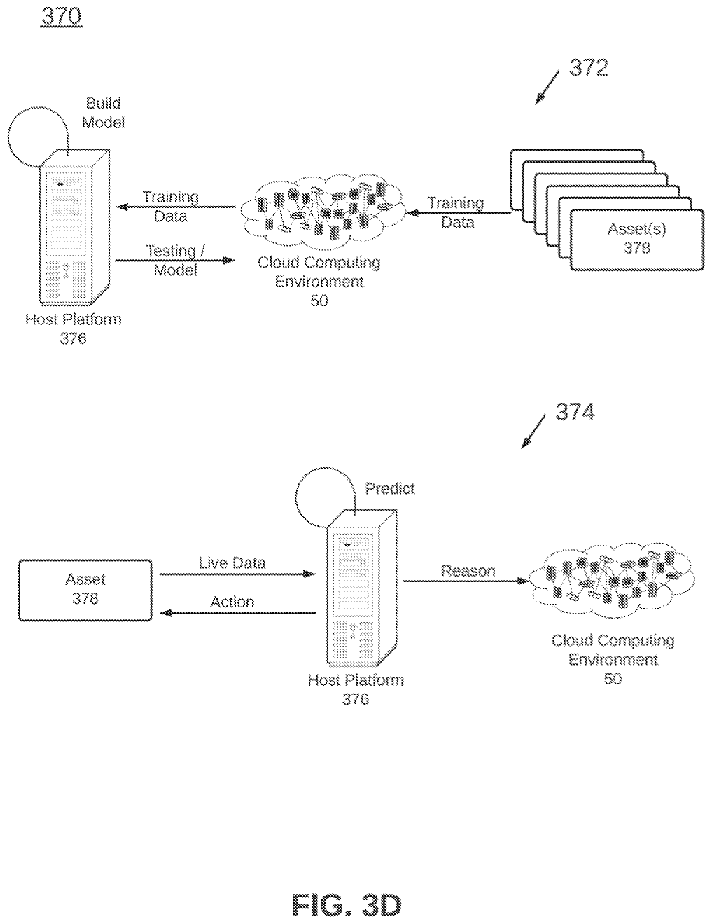

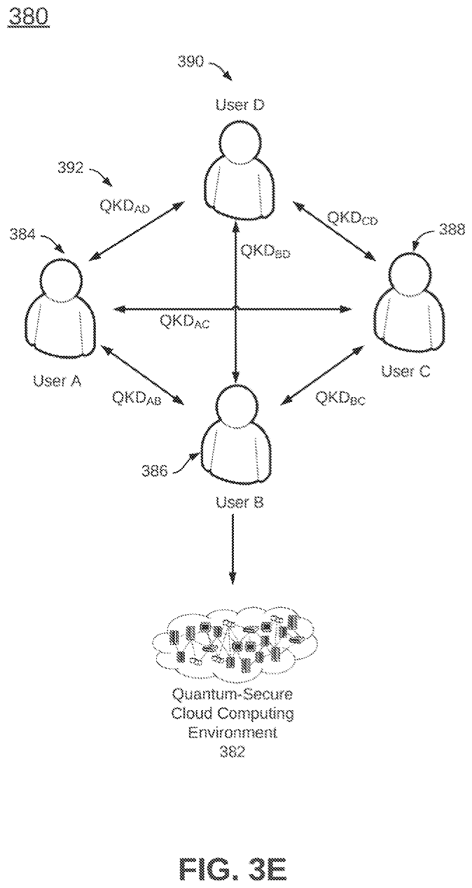

FIG. 3A illustrates an example of a permissioned blockchain network 300, which features a distributed, decentralized peer-to-peer architecture. The blockchain network may interact with the cloud computing environment 160, allowing additional functionality such as peer-to-peer authentication for data written to a distributed ledger. In this example, a blockchain user 302 may initiate a transaction to the permissioned blockchain 304. In this example, the transaction can be a deploy, invoke, or query, and may be issued through a client-side application leveraging an SDK, directly through an API, etc. Networks may provide access to a regulator 306, such as an auditor. A blockchain network operator 308 manages member permissions, such as enrolling the regulator 306 as an “auditor” and the blockchain user 302 as a “client”. An auditor could be restricted only to querying the ledger, whereas a client could be authorized to deploy, invoke, and query certain types of chaincode.

A blockchain developer 310 can write chaincode and client-side applications. The blockchain developer 310 can deploy chaincode directly to the network through an interface. To include credentials from a traditional data source 312 in chaincode, the developer 310 could use an out-of-band connection to access the data. In this example, the blockchain user 302 connects to the permissioned blockchain 304 through a peer node 314. Before proceeding with any transactions, the peer node 314 retrieves the user's enrollment and transaction certificates from a certificate authority 316, which manages user roles and permissions. In some cases, blockchain users must possess these digital certificates in order to transact on the permissioned blockchain 304. Meanwhile, a user attempting to utilize chaincode may be required to verify their credentials on the traditional data source 312. To confirm the user's authorization, chaincode can use an out-of-band connection to this data through a traditional processing platform 318.

FIG. 3B illustrates another example of a permissioned blockchain network 320, which features a distributed, decentralized peer-to-peer architecture. In this example, a blockchain user 322 may submit a transaction to the permissioned blockchain 324. In this example, the transaction can be a deploy, invoke, or query, and may be issued through a client-side application leveraging an SDK, directly through an API, etc. Networks may provide access to a regulator 326, such as an auditor. A blockchain network operator 328 manages member permissions, such as enrolling the regulator 326 as an “auditor” and the blockchain user 322 as a “client”. An auditor could be restricted only to querying the ledger, whereas a client could be authorized to deploy, invoke, and query certain types of chaincode.

A blockchain developer 330 writes chaincode and client-side applications. The blockchain developer 330 can deploy chaincode directly to the network through an interface. To include credentials from a traditional data source 332 in chaincode, the developer 330 could use an out-of-band connection to access the data. In this example, the blockchain user 322 connects to the network through a peer node 334. Before proceeding with any transactions, the peer node 334 retrieves the user's enrollment and transaction certificates from the certificate authority 336. In some cases, blockchain users must possess these digital certificates in order to transact on the permissioned blockchain 324. Meanwhile, a user attempting to utilize chaincode may be required to verify their credentials on the traditional data source 332. To confirm the user's authorization, chaincode can use an out-of-band connection to this data through a traditional processing platform 338.

In some embodiments, the blockchain herein may be a permissionless blockchain. In contrast with permissioned blockchains, which require permission to join, anyone can join a permissionless blockchain. For example, to join a permissionless blockchain a user may create a personal address and begin interacting with the network by submitting transactions and hence adding entries to the ledger. Additionally, all parties have the choice of running a node on the system and employing the mining protocols to help verify transactions.

FIG. 3C illustrates a process 350 of a transaction being processed by a permissionless blockchain 352, including a plurality of nodes 354. A sender 356 desires to send payment or some other form of value (e.g., a deed, medical records, a contract, a good, a service, or any other asset that can be encapsulated in a digital record) to a recipient 358 via the permissionless blockchain 352. In one embodiment, each of the sender device 356 and the recipient device 358 may have digital wallets (associated with the blockchain 352) that provide user interface controls and a display of transaction parameters. In response, the transaction is broadcast throughout the blockchain 352 to the nodes 354. Depending on the blockchain's 352 network parameters, the nodes verify 360 the transaction based on rules (which may be pre-defined or dynamically allocated) established by the permissionless blockchain 352 creators. For example, this may include verifying the identities of the parties involved, etc. The transaction may be verified immediately or it may be placed in a queue with other transactions, and the nodes 354 determine if the transactions are valid based on a set of network rules.

In structure 362, valid transactions are formed into a block and sealed with a lock (hash). This process may be performed by mining nodes among the nodes 354. Mining nodes may utilize additional software specifically for mining and creating blocks for the permissionless blockchain 352. Each block may be identified by a hash (e.g., 256-bit number, etc.) created using an algorithm agreed upon by the network. Each block may include a header, a pointer or reference to a hash of a previous block's header in the chain, and a group of valid transactions. The reference to the previous block's hash is associated with the creation of the secure independent chain of blocks.

Before blocks can be added to the blockchain, the blocks must be validated. Validation for the permissionless blockchain 352 may include a proof-of-work (PoW) which is a solution to a puzzle derived from the block's header. Although not shown in the example of FIG. 3C, another process for validating a block is proof-of-stake. Unlike the proof-of-work, where the algorithm rewards miners who solve mathematical problems, with the proof of stake, a creator of a new block is chosen in a deterministic way, depending on its wealth, also defined as “stake.” Then, a similar proof is performed by the selected/chosen node.

With mining 364, nodes try to solve the block by making incremental changes to one variable until the solution satisfies a network-wide target. This creates the PoW, thereby ensuring correct answers. In other words, a potential solution must prove that computing resources were drained in solving the problem. In some types of permissionless blockchains, miners may be rewarded with value (e.g., coins, etc.) for correctly mining a block.

Here, the PoW process, alongside the chaining of blocks, makes modifications of the blockchain extremely difficult, as an attacker must modify all subsequent blocks in order for the modifications of one block to be accepted. Furthermore, as new blocks are mined, the difficulty of modifying a block increases, and the number of subsequent blocks increases. With distribution 366, the successfully validated block is distributed through the permissionless blockchain 352, and all nodes 354 add the block to a majority chain which is the permissionless blockchain's 352 auditable ledger. Furthermore, the value in the transaction submitted by the sender 356 is deposited or otherwise transferred to the digital wallet of the recipient device 358.

FIGS. 3D and 3E illustrate additional examples of use cases for cloud computing that may be incorporated and used herein. FIG. 3D illustrates an example 370 of a cloud computing environment 160, which stores machine learning (artificial intelligence) data. Machine learning relies on vast quantities of historical data (or training data) to build predictive models for accurate prediction on new data. Machine learning software (e.g., neural networks, etc.) can often sift through millions of records to unearth non-intuitive patterns.

In the example of FIG. 3D, a host platform 376, builds and deploys a machine learning model for predictive monitoring of assets 378. Here, the host platform 366 may be a cloud platform, an industrial server, a web server, a personal computer, a user device, and the like. Assets 378 can be any type of asset (e.g., machine or equipment, etc.) such as an aircraft, locomotive, turbine, medical machinery and equipment, oil and gas equipment, boats, ships, vehicles, and the like. As another example, assets 378 may be non-tangible assets such as stocks, currency, digital coins, insurance, or the like.

The cloud computing environment 160 can be used to significantly improve both a training process 372 of the machine learning model and a predictive process 374 based on a trained machine learning model. For example, in 372, rather than requiring a data scientist/engineer or another user to collect the data, historical data may be stored by the assets 378 themselves (or through an intermediary, not shown) on the cloud computing environment 160. This can significantly reduce the collection time needed by the host platform 376 when performing predictive model training. For example, data can be directly and reliably transferred straight from its place of origin to the cloud computing environment 160. By using the cloud computing environment 160 to ensure the security and ownership of the collected data, smart contracts may directly send the data from the assets to the individuals that use the data for building a machine learning model. This allows for sharing of data among the assets 378.

Furthermore, training of the machine learning model on the collected data may take rounds of refinement and testing by the host platform 376. Each round may be based on additional data or data that was not previously considered to help expand the knowledge of the machine learning model. In 372, the different training and testing steps (and the associated data) may be stored on the cloud computing environment 160 by the host platform 376. Each refinement of the machine learning model (e.g., changes in variables, weights, etc.) may be stored in the cloud computing environment 160 to provide verifiable proof of how the model was trained and what data was used to train the model. For example, the machine learning model may be stored on a blockchain to provide verifiable proof. Furthermore, when the host platform 376 has achieved a trained model, the resulting model may be stored on the cloud computing environment 160.

After the model has been trained, it may be deployed to a live environment where it can make predictions/decisions based on executing the final trained machine learning model. For example, in 374, the machine learning model may be used for condition-based maintenance (CBM) for an asset such as an aircraft, a wind turbine, a healthcare machine, and the like. In this example, data fed back from asset 378 may be input into the machine learning model and used to make event predictions such as failure events, error codes, and the like. Determinations made by executing the machine learning model at the host platform 376 may be stored on the cloud computing environment 160 to provide auditable/verifiable proof. As one non-limiting example, the machine learning model may predict a future breakdown/failure to a part of the asset 378 and create an alert or a notification to replace the part. The data behind this decision may be stored by the host platform 376 and/or on the cloud computing environment 160. In one embodiment, the features and/or the actions described and/or depicted herein can occur on or with respect to the cloud computing environment 160.

FIG. 3E illustrates an example 380 of a quantum-secure cloud computing environment 382, which implements quantum key distribution (QKD) to protect against a quantum computing attack. In this example, cloud computing users can verify each other's identities using QKD. This sends information using quantum particles such as photons, which cannot be copied by an eavesdropper without destroying them. In this way, a sender and a receiver through the cloud computing environment can be sure of each other's identity.

In the example of FIG. 3E, four users are present 384, 386, 388, and 390. Each pair of users may share a secret key 392 (i.e., a QKD) between themselves. Since there are four nodes in this example, six pairs of nodes exist, and therefore six different secret keys 392 are used, including QKD_{AB}, QKD_{AC}, QKD_{AD}, QKD_{BC}, QKD_{BD}, and QKD_{CD}. Each pair can create a QKD by sending information using quantum particles such as photons, which cannot be copied by an eavesdropper without destroying them. In this way, a pair of users can be sure of each other's identity.

The operation of the cloud computing environment 382 is based on two procedures (i) creation of transactions and (ii) construction of blocks that aggregate the new transactions. New transactions may be created similar to a traditional network, such as a blockchain network. Each transaction may contain information about a sender, a receiver, a time of creation, an amount (or value) to be transferred, a list of reference transactions that justifies the sender has funds for the operation, and the like. This transaction record is then sent to all other nodes, where it is entered into a pool of unconfirmed transactions. Here, two parties (i.e., a pair of users from among 384-390) authenticate the transaction by providing their shared secret key 392 (QKD). This quantum signature can be attached to every transaction, making it exceedingly difficult to be tampered with. Each node checks its entries with respect to a local copy of the cloud computing environment 382 to verify that each transaction has sufficient funds.

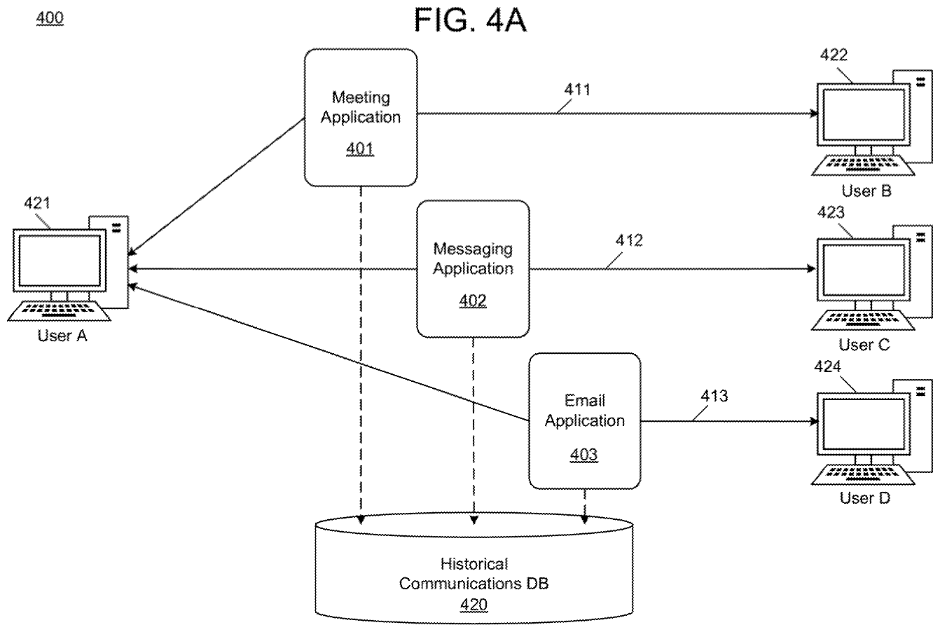

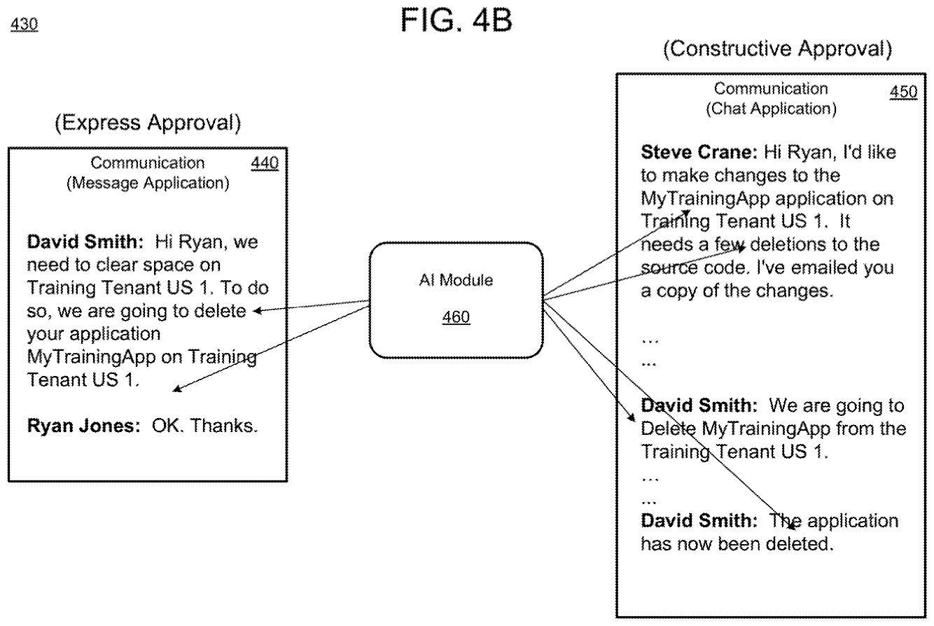

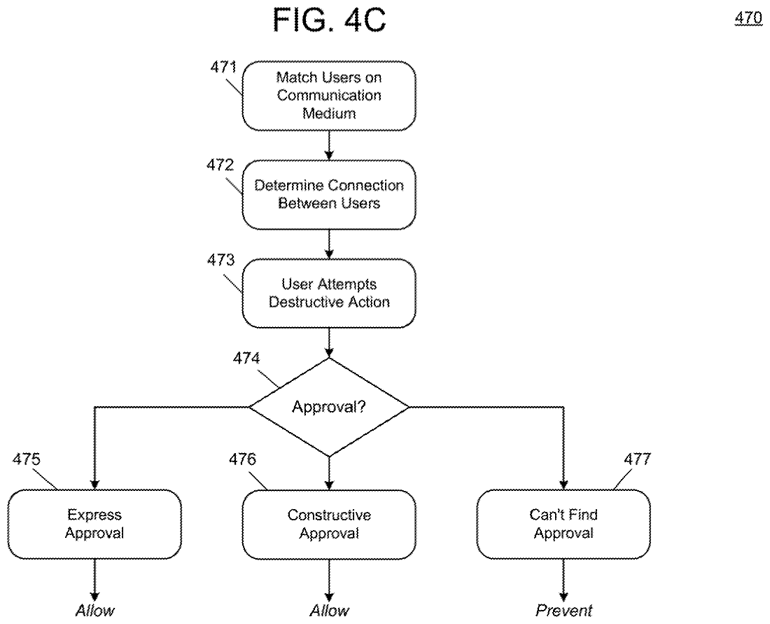

FIG. 4A illustrates a process 400 of capturing communications between a user (user device 421 and a plurality of other users (user devices 422, 423, and 424) according to example embodiments. Referring to FIG. 4A, the host platform (not shown) may integrate into each of a plurality of channels 411, 412, and 413, corresponding to a meeting application 401, a messaging application 402, and an email application 403, respectively, and capture communications that are sent and receive via the applications 401, 402, and 403 within the channels 411, 412, and 413. For example, communications sent between the user 421 and other users (including users 422, 423, and 424), and vice versa, may be captured and stored by the system in a historical communication database 420. In addition, the communications may continually be updated and used to refresh the historical communications database 420.

FIG. 4B illustrates a process 430 of identifying patterns within historical communications 440 and 450 via an artificial intelligence module 460, according to example embodiments. For example, the artificial intelligence module 460 may be the AI module 233 in FIG. 2B. In this example, the AI module 440 may analyze text content within a historical communication 440 (such as an instant message) and identify express approval of the destructive modification of a software artifact based on the content therein. In particular, in FIG. 4A, the communication 440 includes a message in which a first user (David) tells a second user (Ryan) that he is deleting Ryan's software artifact. In response, Ryan responds with a confirmation which is indicative of Ryan being the rightful owner of the software artifact. The AI module 460 may identify this pattern of communication as express approval of deletion of a software artifact (MyTrainingApp). Accordingly, if the second user (Ryan) were to attempt to delete the software application on another site or storage structure of the tenant, the AI module 460 may allow such operation because Ryan is expressly authorized/approved to do so, as determined by the AI module 460.

Meanwhile, communication 450 includes a sequence of communications in which the second user (Ryan) does not confirm the ownership of the software application (MyTrainingApp). Instead, Ryan does not respond. However, based on the frequency of occurrence of such messages including keywords such as “delete” and other synonyms, the AI module 460 may determine that constructive authorization/approval exists. In this case, the AI module 460 may identify multiple communications which indicate an ownership relationship but which do not confirm such relationship. In this case, if Ryan were to again try to delete the application (MyTrainingApp), the AI module 460 would allow it because Ryan is constructive authorized/approved to do so.

According to various embodiments, system users and administrators may opt into the AI module and give it scope of access to applications monitored and communication pathways between users. Here, the AI module ingests a level of validation as per the stringency of the desired implementation. In some embodiments, the AI module may determine a threshold based on number of communication events in a predefined period of time or based on specific NLP in communications. Furthermore, the AI module may gauge all communication pathways between the dev ops team that has deleted access and control versus the end user team that is involved with the application at a day to day level.

The AI module may weight keywords and communications based on the content therein. Furthermore, the AI module may determine a synchronicity frequency score based on how often two users communicate. This score is a simple score that is calculated based on how many times communication is done between the parties. Further, the communication may be weighted via NLP and speech-to-text between the two parties looking for specific indicative text. The indicative text may include specific key words or phrases that are indicative of the dev ops user preparing to delete the environment. In some embodiments, a response to the communication is captured and indexed to determine if it's an approval, constructive approval, undetermined, or unapproved. The speech measured may be a user's response or interaction and view time to capture expected values.

FIG. 4C illustrates a process 470 of determining whether a destructive modification can be performed to a software artifact according to example embodiments. For example, the process 470 may be carried out by a host platform including an AI module as described herein after the AI module has been integrated with the communication applications and channels. Referring to FIG. 4C, in 471, users that are on the same communication medium (e.g., email, etc.) are identified and connections between the users (indicative of relationships between the users, as well as software artifacts) can be identified in 472.

In 473, the AI module detects a user attempting to perform a destructive modification to a software artifact. For example, the user may attempt to delete a software application that is currently stored within a shared database in a tenant environment. In response, the AI module may intercept the request and determine whether the destructive modification is approved, in 474. For example, the AI module may analyze historical communications between the requesting user and other users within the medium to see if they indicate express or constructive approval. If express approval is identified in 475, the destructive modification is allowed. Also, if constructive approval is identified in 476, the destructive modification is allowed. If, however, the approval cannot be identified in 477, the destructive modification is prevented, for example, via an HTTP deletion request or by discarding the request.

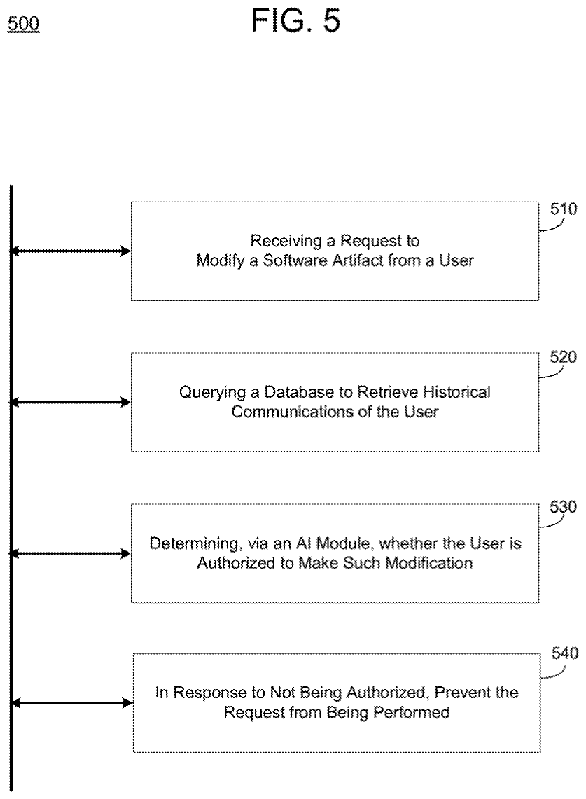

FIG. 5 illustrates a method 500 of determining whether a user can modify a software artifact based on historical communications according to example embodiments. For example, the method may be performed by a cloud platform, a web server, a distributed network of devices and systems, or other computing system. Referring to FIG. 5, in 510, the method may include receiving a request to modify a software artifact stored on a host platform. For example, the modification may include a destructive modification such as a deletion of data from a storage of the software artifact, modification to user permissions, deletion of the software artifact, or any other destructive action.

In 520, the method may include querying a database based on a user identifier associated with the request to retrieve historical communications of a user from the database. In 530, the method may include executing an artificial intelligence (AI) model based on the historical communications to determine whether the user is authorized to modify the software artifact. In response to the determination, in 540 the method may include preventing the request to modify the software artifact from being performed to the software artifact on the host platform.

In some embodiments, the request may include a request to delete the software artifact from a data store of the host platform, and the executing comprises executing the AI model to determine whether the user is authorized to delete the software artifact based on frequency of communications associated with the software artifact within the historical communication. In some embodiments, the preventing may include deleting the request to modify the software artifact without executing it and transmitting an error message to a computing terminal that submitted the request the request in response to determining that the user is not authorized to modify the software artifact.

In some embodiments, the software artifact is hosted within a tenant environment of the host platform, and the querying may include querying one or more of a meeting application, an email application, a call log, and a chat application, within the tenant environment, to retrieve historical communications of the user. In some embodiments, the method may further include identifying a role of the user within the host platform, overriding the determination that the user is not authorized to modify the software artifact based on the identified role, and modifying the software artifact according to the request.

In some embodiments, the executing may include executing the AI model to identify the software artifact associated with the request. In some embodiments, the transmitting may include transmitting a notification to another computing terminal with an identification of a future point in time when the software artifact will be modified, in response to a determination that the user is authorized to modify the software artifact. In some embodiments, the method may further include assigning weights to communications from among the historical communications based on natural language processing (NLP) and frequency of keywords, and execute the AI module on the historical communications based on the assigned weights.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

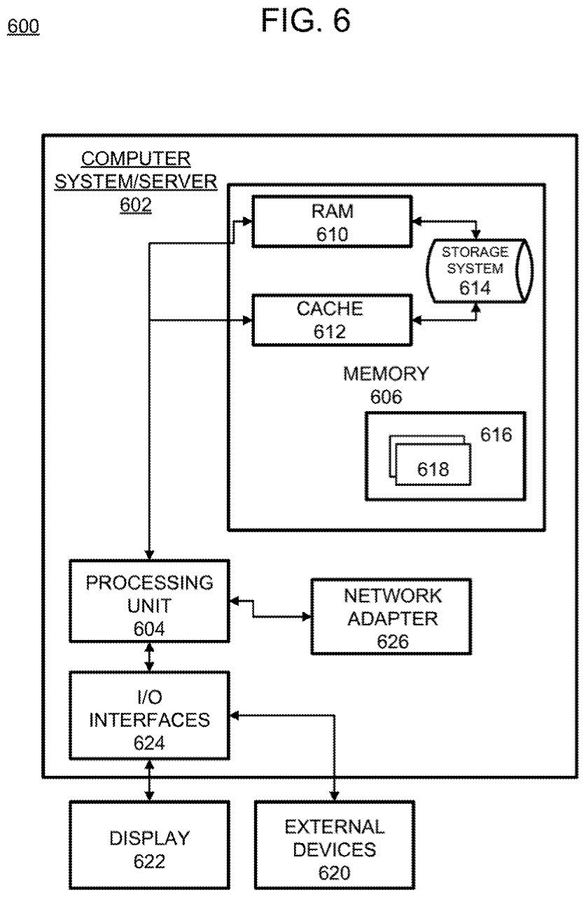

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components. For example, FIG. 6 illustrates an example computer system architecture 600, which may represent or be integrated in any of the above-described components, etc.

FIG. 6 illustrates an example system 600 that supports one or more of the example embodiments described and/or depicted herein. The system 600 comprises a computer system/server 602, which is operational with numerous other general purpose or special purpose computing system environments or configurations. Examples of well-known computing systems, environments, and/or configurations that may be suitable for use with computer system/server 602 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 602 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 602 may be practiced in distributed cloud computing environments where tasks are performed by remote processing devices that are linked through a communications network. In a distributed cloud computing environment, program modules may be located in both local and remote computer system storage media, including memory storage devices.

As shown in FIG. 6, computer system/server 602 in cloud computing node 600 is shown in the form of a general-purpose computing device. The components of computer system/server 602 may include, but are not limited to, one or more processors or processing units 604, a system memory 606, and a bus that couples various system components, including system memory 606 to processor 604.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 602 typically includes a variety of computer system readable media. Such media may be any available media that is accessible by computer system/server 602, and it includes both volatile and non-volatile media, removable and non-removable media. System memory 606, in one embodiment, implements the flow diagrams of the other figures. The system memory 606 can include computer system readable media in the form of volatile memory, such as random-access memory (RAM) 610 and/or cache memory 612. Computer system/server 602 may further include other removable/non-removable, volatile/non-volatile computer system storage media. By way of example only, storage system 614 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”) and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 606 may include at least one program product having a set (e.g., at least one) of program modules that are configured to carry out the functions of various embodiments of the application.

Program/utility 616, having a set (at least one) of program modules 618, may be stored in memory 606 by way of example, and not limitation, as well as an operating system, one or more application programs, other program modules, and program data. Each of the operating system, one or more application programs, other program modules, and program data or some combination thereof may include an implementation of a networking environment. Program modules 618 generally carry out the functions and/or methodologies of various application embodiments as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 602 may also communicate with one or more external devices 620 such as a keyboard, a pointing device, a display 622, etc.; one or more devices that enable a user to interact with computer system/server 602; and/or any devices (e.g., network card, modem, etc.) that enable computer system/server 602 to communicate with one or more other computing devices. Such communication can occur via I/O interfaces 624. Still yet, computer system/server 602 can communicate with one or more networks such as a local area network (LAN), a general wide area network (WAN), and/or a public network (e.g., the Internet) via network adapter 626. As depicted, network adapter 626 communicates with the other components of computer system/server 602 via a bus. It should be understood that although not shown, other hardware and/or software components could be used in conjunction with computer system/server 602. Examples include, but are not limited to: microcode, device drivers, redundant processing units, external disk drive arrays, RAID systems, tape drives, data archival storage systems, etc.

Although an exemplary embodiment of at least one of a system, method, and computer readable medium has been illustrated in the accompanying drawings and described in the foregoing detailed description, it will be understood that the application is not limited to the embodiments disclosed but is capable of numerous rearrangements, modifications, and substitutions as set forth and defined by the following claims. For example, the system's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone, or any other suitable computing device, or combination of devices. Presenting the above-described functions as being performed by a “system” is not intended to limit the scope of the present application in any way but is intended to provide one example of many embodiments. Indeed, methods, systems, and apparatuses disclosed herein may be implemented in localized and distributed forms consistent with computing technology.

It should be noted that some of the system features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only, and the scope of the application is to be defined solely by the appended claims when considered with a full range of equivalents and modifications (e.g., protocols, hardware devices, software platforms, etc.) thereto.

What is claimed is:

1. An apparatus comprising:
a processor configured to
receive a request to modify a software artifact stored on a host platform;
query a database based on a user identifier associated with the request to retrieve historical communications of a user from the database;
execute an artificial intelligence (AI) model based on the historical communications to determine whether the user is authorized to modify the software artifact; and
in response to a determination that the user is not authorized, prevent the request to modify the software artifact from being performed to the software artifact.

2. The apparatus of claim 1, wherein the request comprises a request to delete the software artifact from a data store of the host platform, and the processor is configured to execute the AI model to determine whether the user is authorized to delete the software artifact based on frequency of communications associated with the software artifact within the historical communication.

3. The apparatus of claim 1, wherein the processor is configured delete the request to modify the software artifact without executing it and transmit an error message to a computing terminal that submitted the request in response to determining that the user is not authorized to modify the software artifact.

4. The apparatus of claim 1, wherein the software artifact is hosted within a tenant environment of the host platform, and the processor is configured to query one or more of a meeting application, an email application, a call log, and a chat application, within the tenant environment, to retrieve historical communications of the user.

5. The apparatus of claim 1, wherein the processor is further configured to identify a role of the user within the host platform, override the determination that the user is not authorized to modify the software artifact based on the identified role, and modify the software artifact according to the request.

6. The apparatus of claim 1, wherein the processor is configured to execute the AI model to identify the software artifact associated with the request.

7. The apparatus of claim 1, wherein the processor is further configured to transmit a notification to another computing terminal with an identification of a future point in time when the software artifact will be modified, in response to a determination that the user is authorized to modify the software artifact.

8. The apparatus of claim 1, wherein the processor is configured to assign weights to communications from among the historical communications based on natural language processing (NLP) and frequency of keywords, and execute the AI module on the historical communications based on the assigned weights.

9. A method comprising:
receiving a request to modify a software artifact stored on a host platform;
querying a database based on a user identifier associated with the request to retrieve historical communications of a user from the database;
executing an artificial intelligence (AI) model based on the historical communications to determine whether the user is authorized to modify the software artifact; and
in response to a determination that the user is not authorized, preventing the request to modify the software artifact from being performed to the software artifact.

10. The method of claim 9, wherein the request comprises a request to delete the software artifact from a data store of the host platform, and the executing comprises executing the AI model to determine whether the user is authorized to delete the software artifact based on frequency of communications associated with the software artifact within the historical communication.

11. The method of claim 9, wherein the preventing comprises deleting the request to modify the software artifact without executing it and transmitting an error message to a computing terminal that submitted the request the request in response to determining that the user is not authorized to modify the software artifact.

12. The method of claim 9, wherein the software artifact is hosted within a tenant environment of the host platform, and the querying comprises querying one or more of a meeting application, an email application, a call log, and a chat application, within the tenant environment, to retrieve historical communications of the user.

13. The method of claim 9, wherein the method further comprises identifying a role of the user within the host platform, overriding the determination that the user is not authorized to modify the software artifact based on the identified role, and modifying the software artifact according to the request.

14. The method of claim 9, wherein the executing comprises executing the AI model to identify the software artifact associated with the request.

15. The method of claim 9, wherein the transmitting comprises transmitting a notification to another computing terminal with an identification of a future point in time when the software artifact will be modified, in response to a determination that the user is authorized to modify the software artifact.

16. The method of claim 9, wherein the method further comprises assigning weights to communications from among the historical communications based on natural language processing (NLP) and frequency of keywords, and execute the AI module on the historical communications based on the assigned weights.

17. A computer-readable storage medium comprising instructions, that when read by a processor, cause the processor to perform a method comprising:
receiving a request to modify a software artifact stored on a host platform;
querying a database based on a user identifier associated with the request to retrieve historical communications of a user from the database;
executing an artificial intelligence (AI) model based on the historical communications to determine whether the user is authorized to modify the software artifact; and
in response to a determination that the user is not authorized, preventing the request to modify the software artifact from being performed to the software artifact.

18. The computer-readable storage medium of claim 17, wherein the request comprises a request to delete the software artifact from a data store of the host platform, and the executing comprises executing the AI model to determine whether the user is authorized to delete the software artifact based on frequency of communications associated with the software artifact within the historical communication.

19. The computer-readable storage medium of claim 17, wherein the preventing comprises deleting the request to modify the software artifact without executing it and transmitting an error message to a computing terminal that submitted the request the request in response to determining that the user is not authorized to modify the software artifact.

20. The computer-readable storage medium of claim 17, wherein the software artifact is hosted within a tenant environment of the host platform, and the querying comprises querying one or more of a meeting application, an email application, a call log, and a chat application, within the tenant environment, to retrieve historical communications of the user.
